(19) United States
(12) Patent Application Publication
(10) Pub. No.: US 2014/0199489 A1
(43) Pub. Date: Jul. 17, 2014

(54) Applicator for polishing solution

(71) Applicant: Sadie King, Memphis, TN (US)

(72) Inventor: Sadie King, Memphis, TN (US)

(21) Appl. No.: 14/154,058

(22) Filed: Jan. 13, 2014

Related U.S. Application Data
(60) Provisional application No. 61/752,949, filed on Jan. 15, 2013.

(51) Int. Cl. B05C 1/00; B05D 1/28

(52) U.S. Cl. CPC B05C 1/00; B05D 1/28
USPC 427/429; 401/143

(57) ABSTRACT

An applicator for vehicle polishing solution is provided. The user would fill the handle of the device with polishing solution and would be able to continuously polish the vehicle, dispersing the polishing solution at a controlled interval. This applicator would have a hollow tube constituting the handle of the device, which would curve approximately ninety degrees at each end. The top of the handle would have an opening to fill the device and an opening at the bottom to disperse the solution onto the sponge for application. The middle section of the handle would have a button that would enable the user to control the outflow of the solution onto the sponge. The bottom of the handle would be a ball-and-socket swivel joint that would connect the handle to a sponge mount, allowing the sponge mount to be tilted and rotated relative to the handle.

### CROSS-REFERENCE TO RELATED APPLICATIONS

This application claims priority to U.S. Provisional Application No. 61/752,949 (filed Jan. 15, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates to applicators for polishing solutions, and in particular to a self-refilling applicator for polishing solutions. Vehicle owners, auto dealers and detailing shops often polish their vehicles and their vehicle tires. The process involves moistening a soft cloth pad or sponge with polish, and then applying it to the surface to be polished. This polish is quickly depleted by being left as a thin film on the polished surface. Adding more polish to the sponge every sixty to ninety seconds makes the task of polishing much more time consuming, and increases the risk of spills. Placing the sponge back on the surface to be polished also leaves a visible mark in the wet film of polish, and this mark must polished out, adding more time and effort to the task. Making an applicator with a sponge that refills itself would substantially reduce the amount of time and effort required for the task. The prior art discloses a number of general purpose and specialized applicators which are self-refilling, but these generally have a heavy and cumbersome hose and electric pump leading to a bottle, can or reservoir of polish. This invention has a reservoir of polish contained within a long, balanced handle, with a release button to allow more polish to flow to the sponge surface during the polishing process.

### SUMMARY OF THE INVENTION

Accordingly, the invention is directed to a self-refilling applicator for polishing solution. This applicator would have a long, hollow handle that curves approximately ninety degrees at the top and bottom. The top would have an opening for pouring in polishing solution. The middle of the handle would have a button that, while pressed, would open a valve in the hollow portion of the handle. This would allow the user to selectively allow fluid to pass through the handle and out of the bottom. Attached to the bottom of the handle would be a hollow ball-and-socket type swivel joint that would connect to a sponge mount. The joint would allow for the sponge mount to be tilted and rotated relative to the handle. Mounted inside the sponge mount would be the sponge applicator, into which polishing solution flowing from the handle would diffuse. The sponge would be removable and would be provided in a variety of widths. It would have a flexible, curved front surface to conform to the contours of particular tires, fenders, bumpers and other vehicle surfaces. The user would remove a threaded cap, fill the top of the handle with solution and replace the cap, ready the sponge on the surface to be polished, and then press the button to release the fluid into the sponge. The user would then rub the sponge over the surface to apply the polishing solution.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a side view of the secondary overhead frame of the first exemplary embodiment, showing the handle 10, the cap 11, the button 12, the socket member 13, the sponge mount 14, and the sponge 15, the ball member 16, the handle top end 100, the handle bottom end 101, and the handle central section 102.

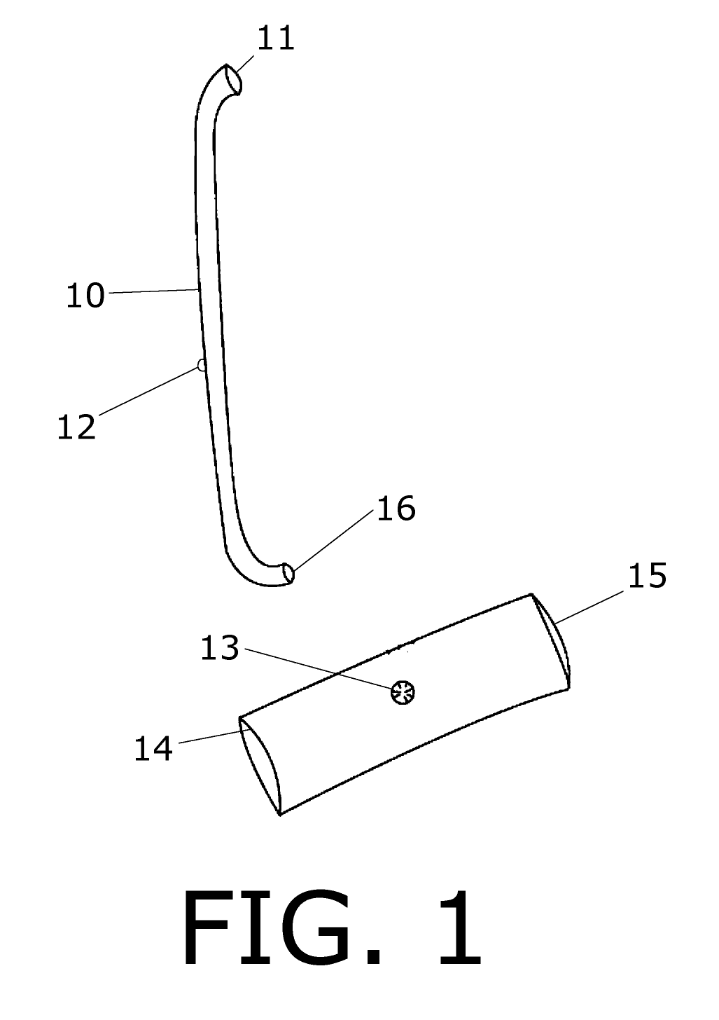

### DETAILED DESCRIPTION OF THE INVENTION

Referring now to the invention in more detail, the invention is directed to a self-refilling applicator for polishing solution. This applicator would have a long, hollow handle that curves approximately ninety degrees at the top and bottom. The top would have an opening for pouring in polishing solution. The middle of the handle 10 would have a button 12 that, while pressed, would open a valve in the hollow portion of the handle 10. This would allow the user to selectively allow polishing solution to pass through the handle 10 and out of the bottom. Attached to the bottom of the handle 10 would be a hollow ball-and-socket type swivel joint that would connect to a sponge mount 14. The swivel joint would allow for the sponge mount 14 to be tilted and rotated relative to the handle 10.

Mounted inside the sponge mount 14 would be the sponge applicator, into which polishing solution flowing from the handle 10 would diffuse. The sponge 15 would be capable of being attached and removed by sliding into and out of a pair of closely fitted slots on the sponge mount 14. The sponge 15 would have a flexible, curved front surface to conform to the contours of particular tires, fenders, bumpers and other vehicle surfaces, and would be supplied in a variety of widths and curvatures.

The user would remove a threaded cap 11, fill the top of the handle 10 with solution and replace the cap 11, ready the sponge 15 on the surface to be polished, and then press the button 12 to release the fluid into the sponge 15. The user would then rub the sponge 15 over the surface to apply the polishing solution.

The swivel joint would be comprised of a socket member 13 configured to engage with a ball member 16. The socket member 13 would be comprised of a chamber for holding the ball member 16 in a substantially freely rotating manner, and a pair of lips defining an opening through which the ball member is insertable into the socket chamber. The lips would yield in a flexible and resilient manner to permit the ball member to be forcibly inserted into and removed from the socket chamber through the opening, yet grasping the ball member 16 when inserted into the socket chamber.

The handle 10, cap 11, button 12, socket member 13, ball member 16, and sponge mount 14 would be manufactured from inexpensive, rigid, high-impact materials such as injection molded plastic, aluminum, steel, or similar materials. The sponge 15 would preferably be manufactured from natural sea sponge.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A polishing solution applicator comprising:
(a) a handle;
(b) said handle comprising a top end, a bottom end, and a central section;
(c) said handle being hollow;
(d) said handle being configured such that said top end is curved about 90° relative to said central section;
(e) said handle being configured such that said bottom end is curved about 90° relative to said central section;
(f) a threaded cap;
(g) said top end of said handle being configured such that said threaded cap may be removably engaged thereto;
(h) a button;
(i) said button being positioned on said central section of said handle;
(j) said button being configured to selectively permit the internal passage of fluid within said handle;
(j) a sponge mount;
(k) a sponge;
(l) said sponge being affixed to said sponge mount;
(m) a socket member;
(n) said socket member being hollow and configured to conduct fluid through itself;
(o) said socket member being affixed to said sponge mount in a manner opposite said sponge such that fluid may be conducted through said socket member and said sponge mount and impregnate said sponge;
(p) a ball member;
(q) said socket member being configured to releasably engage to said ball member;
(r) said ball member being hollow and configured to conduct fluid through itself; and
(s) said ball member being affixed to said lower end of said handle such that fluid may be conducted through said ball member.

2. The polishing solution applicator of claim 1 wherein said sponge further comprises a flexible, curved front surface.

3. A method of using the polishing solution applicator of claim 1 comprising removing said threaded cap, filling said handle with a solution, replacing said threaded cap, applying said sponge to a surface, actuating said button until said sponge is impregnated with said solution, applying said solution to said surface, and continuing until said surface is fully polished while actuating said button as necessary to maintain impregnation of said sponge with said solution.

4. A method of using the polishing solution applicator of claim 2 comprising removing said threaded cap, filling said handle with a solution, replacing said threaded cap, applying said sponge to a surface, actuating said button until said sponge is impregnated with said solution, applying said solution to said surface, and continuing until said surface is fully polished while actuating said button as necessary to maintain impregnation of said sponge with said solution.

5. The polishing solution applicator of claim 1 wherein said sponge is made of natural sea sponge.

6. The polishing solution applicator of claim 5 wherein said sponge is made of natural sea sponge.

7. A method of using the polishing solution applicator of claim 6 comprising removing said threaded cap, filling said handle with a solution, replacing said threaded cap, applying said sponge to a surface, actuating said button until said sponge is impregnated with said solution, applying said solution to said surface, and continuing until said surface is fully polished while actuating said button as necessary to maintain impregnation of said sponge with said solution.
